(19) United States
(12) Patent Application Publication
(10) Pub. No.: US 2004/0225959 A1
(43) Pub. Date: Nov. 11, 2004

(54) Appearance properties for web applications using TagLibs

(76) Inventors: David D'Orto, Cherry Hill, NJ (US); Peter H. Petersen, Trenton, NJ (US); Gregory Pavlik, Shamong, NJ (US); Neil Kenig, Mount Laurel, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/434,045

(22) Filed: May 8, 2003

(51) Int. Cl. G06F 15/00

(52) U.S. Cl. 715/513

(57) ABSTRACT

In accordance with an embodiment disclosed herein, a method of providing appearance properties information for a web application is provided. The method comprises creating a Tag having attributes that describe the appearance properties information. The method further comprises creating corresponding computer code that implements the appearance properties attributes in the web application. The method further comprises containing a description of the Tag with related attributes and corresponding computer code in a Tag Library (TagLib). The method further comprises inserting the Tag into the web application. The method further comprises, when the inserted Tag is encountered in the web application, then accessing the description of the Tag with related attributes and corresponding computer code in the TagLib and implementing the accessed appearance properties attributes in the web application by executing the corresponding computer code in place of the Tag.

### CROSS-REFERENCE TO RELATED APPLICATIONS

This Application is related to co-pending, concurrently filed, and commonly assigned U.S. patent applications Ser. No. [Attorney Docket No. 100203191-1] entitled “RPC TYPE SOAP SERVICE ACCESS VIA TAGLIBS FOR DYNAMIC WEB CONTENT”; and Ser. No. [Attorney Docket No. 100203194-1] entitled “PRESENTATION OF WEB SITE SUMMARY VIA TAGLIBS”; the disclosures of which are hereby incorporated herein by reference.

### BACKGROUND

Client/Server computing is a programming model, in which two or more entities partake in the solution of a given problem. A client is an entity that needs the solution and a server is an entity that, given enough information (typically in part from the client) can provide the answer. For example, a client, such as a part of an Internet portal like Yahoo™, needs the current price of the stock of a company, in order to display a user's portfolio. A server, such as Nasdaq™ or NYSE can provide the answer, as long as the client can provide it with the stock symbol for the company in question. A client is a software entity (which runs on a piece of hardware) that knows how to contact the server, which is another software entity (which also runs on some piece of hardware), provides enough information, such as a stock symbol, and receives the answer, for example the current price.

Client/server computing is often but not always distributed. In the distributed scenario, there are options, such as telephone or E-mail, for bridging the gap. While functionally equivalent, phone and E-mail communication employ different protocols.

One desirable attribute of clients and servers is that they be protocol independent. In the above example it is technically the client and the server who adapt to the protocol used for phone or E-mail communication. Often in client/server computing there will be proxies involved in the process. A client presents a question to an assistant, who contacts a server assistant, who in turn presents the question to the server; the answer then flows back the same route, but in the opposite direction. The assistants in this example are defined to be proxies, which make the client and server protocol independent, i.e., the proxies handle the protocol. Neither client nor server need know whether the communication was by phone, fax, or E-mail, such that the protocol is completely transparent to both.

Servers are often themselves also clients. If, hypothetically, a server did not know an answer, it could get that answer from someone else, for example a third party specialist. The key thing is that the client is not aware of this second client/server intermediary. While clients and servers might be rather nebulous entities, they all function in a relatively simple manner, exchanging information using proxies and a specific set of protocols.

To some extent contrary to popular belief, the Internet is not a single network per se; rather, it is vast conglomerate of separate networks that are interconnected, allowing a client to reach a server anywhere (the server may not wish to “speak” to the client, or they may not share the same protocol).

In an archetypal use of the Internet, a user needs a piece of information that is available on the Internet (for example, a company's address or phone number). The client is almost always a web browser, for example Internet Explorer™, Netscape™ or Opera. From the user's perspective, the browser is just another application that runs on his/her PC, Mac™ or UNIX™/Linux™ box. From a computing standpoint, the browser is actually a client.

The server, in this example, is generally a web server, such as Microsoft's IIS (Internet Information Server), Apache, or some other equivalent, usually at a company or organization's premises, or at a service provider. Unless the client and server (or their proxies) can agree on a protocol and a language, they cannot communicate. The overwhelmingly most used protocol on the internet is HTTP (HyperText Transfer Protocol), running on a base of a Transmission Control Protocol/Internet Protocol (TCP/IP) lower-level protocol. HTTP was conceived as a means for allowing the use of “hypertext” which embedded “hyperlinks” in digital documents to seamlessly link to additional information without “leaving” the current document. This mechanism is still the core of the Internet, as far as human users are concerned: a document contains links to other documents that (hopefully) relate in some way to the current document.

Since servers potentially can do many things, pointing a browser to www.company-name.com gets their “home page” or some portal-like screen that gives access to other pieces of information, e-commerce™, etc. However, even a simple, small PC-based server can host thousands of documents and hyperlinks, so a finer grained scheme is needed to uniformly locate these resources. The URL (Uniform Resource Locator) is the (often longwinded) complete address name. The browser and the server can often help alleviate most of the details for obtaining default information (such as the home page), but for specific documents, the full URL must be specified.

All URLs are made up of several parts:

1. The protocol (such as HTTP)

2. The server name (or TCP/IP address) (such as www.hp.com)

3. The server port number (usually 80)

4. The name of the document (or resource such as index.html).

Thus a fairly simple URL could look like:

http://www.hp.com/index.html

The port number was omitted since each protocol has a default, so for HTTP the real URL is:

http://www.hp.com:80/index.html

Using this simple string of text tells the browser to:

1. Use HTTP protocol.

2. Go to Dynamic Naming Service (DNS™) and find the TCP/IP address for www.hp.com

3. Open a TCP/IP network connection on port 80 to the server at that address.

4. Ask it for the document called index.html

5. Display the document.

Static content is content simply read from a file (like Word on Windows™ can read a Word document from, e.g., /My Documents/SomeLetter.doc, the web server can read the document from e.g. index.html). With static content, it is implied that no matter who requests the document, it is the same document that is read and sent, and because it resides in a file on a web server, it changes infrequently. Most people have gone to a web site and seen the notice on the bottom of the page: Last modified on xx/xx/xx. Static content is appropriate for encyclopedia data, where potentially vast amounts of facts (or opinions for that matter) need to be stored and made readily available. The content and documents are a set of files in a directory on the hard drive on the server. These files contain the information that the browser needs to display them, which for historical and other reasons is in HTML format. The actual contents of the document have been “marked up” in order to specify the format, such as paragraphs, fonts, tables, etc.

If the following HTML:

<html>

<head>

<title>Welcome to HTML!</title>

</head>
<body>

<h2>Welcome to HTML!</h2>
<p>Welcome to the world of HTML. Everything you see in your web browser is

made up of stuff like this . . .

</body>

</html>

were typed into Windows'™ Notepad and saved to a file, such as welcome.html, upon double-clicking that file, Internet Explorer™ would open and display

Welcome to HTML!

with the words ‘Welcome to HTML!’ in the title bar, the markup is in the document to tell the browser how to format it—as in Internet Explorer™. Right-clicking in Internet Explorer™ and selecting the ‘View Source’ menu item, Notepad opens up and shows everything—including the markup.

However, static content has limitations—certainly the weather could not be presented using static content, nor could an e-commerce™ site be built using it, so a different technology is required. The technology at hand is dynamic content generation, which can be done using a number of programming models and languages. Dynamic content is often created on demand in response to the actual request; take the stock quote example—when one wants the latest quotes, not old ones from an hour ago or yesterday's quotes.

A web request is nothing more than a client sending a URL, a server reading markup text from a file and sending it back to the client. Importantly, the client, for example Internet Explorer™, does not know or care from where the server gets the HTML. Accordingly, the web server does not have to read it from a file, but could get it from elsewhere.

### SUMMARY

In accordance with an embodiment disclosed herein, a method of providing appearance properties information for a web application is provided. The method comprises creating a Tag having attributes that describe the appearance properties information. The method further comprises creating corresponding computer code that implements the appearance properties attributes in the web application. The method further comprises containing a description of the Tag with related attributes and corresponding computer code in a Tag Library (TagLib). The method further comprises inserting the Tag into the web application. The method further comprises, when the inserted Tag is encountered in the web application, then accessing the description of the Tag with related attributes and corresponding computer code in the TagLib and implementing the accessed appearance properties attributes in the web application by executing the corresponding computer code in place of the Tag.

In accordance with another embodiment disclosed herein, a system for providing appearance properties information for a web application is provided. The system comprises a Tag having attributes that describe the appearance properties information. The system further comprises corresponding computer code operable to implement the appearance properties attributes in the web application, and a Tag Library (TagLib) operable to contain a description of the Tag with related attributes and corresponding computer code, and operable to provide the corresponding computer code when accessed from the web application.

In accordance with another embodiment disclosed herein, a system for providing appearance properties information for a web application is provided. The system comprises means for creating a Tag having attributes that describe the appearance properties information, and means for creating corresponding computer code that implements the appearance properties attributes in the web application. The system further comprises means for containing a description of the Tag with related attributes and corresponding computer code in a Tag Library (TagLib). The system further comprises means for inserting the Tag into the web application, and means for accessing the description of the Tag with related attributes and corresponding computer code in the TagLib, when the inserted Tag is encountered in the web application. The system further comprises means for implementing the accessed appearance properties attributes in the web application by executing the corresponding computer code in place of the Tag.

In accordance with another embodiment disclosed herein, computer-executable software code stored to a computer-readable medium is provided. The computer-executable software code comprises software code for creating a Tag having attributes that describe appearance properties information, and software code for creating corresponding computer code that implements said appearance properties attributes in a web application. The computer-executable software code further comprises computer code for containing a description of said Tag with related attributes and corresponding computer code in a Tag Library (TagLib), and computer code for inserting the Tag into a web application. The computer-executable software code further comprises computer code for accessing the description of the Tag with related attributes and corresponding computer code in the TagLib, when the inserted Tag is encountered in the web application, and computer code for implementing the accessed appearance properties attributes in the web application by executing the corresponding computer code in place of the Tag.

### BRIEF DESCRIPTION OF THE DRAWINGS

FIG. 1 is a flow diagram depicting a unified method of providing “look and feel” information for a web application using Tag Libraries (TagLibs), in accordance with the present embodiments; and

FIG. 2 is a schematic representation of the relationships between elements of a unified system for providing “look and feel” information for a web application using TagLibs, in accordance with the present embodiments.

### DETAILED DESCRIPTION

Most Internet standards are relatively old and have evolved over time. Many such standards may appear at face value to be arcane, ineffective or strange, but because the Internet is so distributed and diversified, changing these standards is a cumbersome and slow process.

An application server is a piece of software into which applications can be deployed—and in turn, these applications can generate HTML dynamically, based on who the user is and what information was supplied in the request—i.e. the URL and for example a form that was filled out by the user. An example of this is a weather application, in which a user keys in his/her zip code, for instance, and the weather application obtains the weather forecast for that area over the next few days. Clearly, it would be cumbersome to try to implement this application using static content, but an application server, capable of obtaining the information, can dynamically generate the content in response to a user request. Stock quotes follow similar guidelines, and an e-commerce™ application will generate content based on what the user is interested in purchasing and, e.g., showing the user's shopping cart and perhaps previous orders.

An application server is a complex piece of software that runs on a variety of different computing systems, such as Windows™ PCs, UNIX™/Linux™ servers and IBM mainframe computers. Application servers fall into categories of 1) Windows™ IIS based (basically Microsoft.Net), 2) Java™ J2EE based, and 3) Apache plug-in based. J2EE stands for Java™ version 2 Enterprise Edition and is simply a set of standard Java™ components, used for enterprise computing. A J2EE application server is a standards-conforming large, complex piece of software into which applications, written in the Java™ programming language, can be deployed and accessed by users using a web browser, such as Internet Explorer™ or Netscape™. The user experience is in essence similar to the above example with static content, in that the user either types a URL or clicks a hyperlink (which contains a URL) and receives a response in the form of (typically) an HTML document that the browser displays. The difference is that the HTML in question did not come from a file, as in the static content example, but rather was generated dynamically by the application.

A typical application server allows the deployment of several applications at once, and any number (within certain practical limits) of users can interact with any of the applications simultaneously; for example, retrieving stock portfolio on Yahoo™ while another user checks local weather, also on Yahoo™.

A web application is usually a set of files, containing: 1) static content, such as images and perhaps HTML, 2) application code, known as Java™ class files, 3) application code, along with (typically) HTML markup in JSP™ files (described below in more detail), and 4) sundry configuration information, etc.

Web applications are often organized in directories (or folders), for example, a Letters folder, a Client folder, etc. to put files based on the category they fit. A typical E-mail system, such as Outlook™, also lets a user create folders and move E-mails into them. Outlook™ actually creates directories on the hard drive that match the folder names specified. In a typical web based application, called weather, a set of images might indicate the current cloudiness level (say, overcast, mostly cloudy, mostly sunny, and sunny). Once the weather application has received the weather forecast, it would translate the forecast level of cloudiness into an HTML link to the appropriate image file; e.g. the word “sunny” in the forecast could be translated to the file/images/sunny.gif.

The following example URL is actually taken from the Yahoo™ forecast for Mt. Laurel, N.J., for a Friday, which is supposed to be mostly sunny:

<img src=“http://us.i1.yimg.com/us.yimg.com/i/us/we/52/34.gif” width=52
height=52 alt=“Mostly Sunny” border=0>

The <img> markup is HTML that tells the web browser to go to the URL, specified by the src=“ . . . ” and display the image it retrieves. The alt=“ . . . ” specifies the “tooltip” that pops up when the cursor hovers over the picture—in this case “Mostly Sunny”. The actual URL and directory—and image names are dependent on the actual server and application.

The image in the example is 34.gif; where gif stands for Graphics Interchange Format™, which is a very widely used image format, recognized by all browsers. Two other computer formats are .png and .jpg.

Both web servers and application servers are capable of returning both HTML text documents and non-text image files. In fact, web servers and application servers can return any kind of file, including Word documents, MP3™ music files, movies, PDF files etc. HTML documents are often very large. For example, the Yahoo™ weather page discussed above is about 36000 characters. Creating these pages, whether statically or dynamically, can be time consuming.

Static HTML content is often written by specialists in web design. It is easy to author a simple page, as in the above example, but creating useful, well laid out pages is an art form. Good web page designers are rarely good software developers, and good software developers are rarely good web page designers. The following excerpt of Java™ code generates a simple web page that greets the user with either “good morning” or “good afternoon,” depending on whether the current time is before or after 12:00 noon.

Writer writer = response.getWriter();
writer.println(“<html>”);
writer.println(“\t<head>”);
writer.println(“\t\t<title>Greetings</title>”);
writer.println(“\t</head>”);
writer.println(“\t<body>”);
Date date = new Date();
if(date.getHours() <12) {

writer.println(“<p>Good Morning!”);

} else {

writer.println(“<p>Good Afternoon!”);

}
writer.println(“\t</body>”);
writer.println(“</html>”);

Editing HTML can be strenuous, but in conjunction with Java™ code it becomes cumbersome, so a better, easier way was needed. JavaServer Pages (JSPs™) are simple text files, exactly like normal, static HTML files, but rather than a web server sending them directly to the client, a J2EE application server is needed, so that they can first be processed and executed. What this implies is that JSP™ pages are more than HTML; they conveniently bridge the gap between Java™ and HTML, but from the HTML authors' standpoint rather than the Java™ developers.

The above greeting example can be expressed in a JSP™ as:

<html>

<head>

<title>Greetings</title>

</head>
<body>

<p>
<%

Date date = new Date();
if(date.getHours() <12) {

out.println(“Good Morning!”);

} else {

out.println(“Good Afternoon!”);

}

%>

</body>

</html>

A JSP™ allows Java™ code to be embedded inside normal HTML markup, using the <% and %> markup. If a web browser received this unprocessed, it would not understand it. Thus, the application server needs to process the JSP™ before it can be executed; the result of the execution is the raw markup along with the output (i.e. either “Good Morning!” or “Good Afternoon!”) from the embedded Java™ code. The end result is a HTML document that the web browser can understand and display in exactly the same manner as if the HTML had come from a file.

Although JSPs™ are an order of magnitude easier to create and modify than the Java™ code, they still tend to become cumbersome as more complexity (and thus more Java™ code) is added to the files. It often reaches a point at which a Java™ developer and a web page designer have to sit together to create and modify JSPs™—clearly not an ideal situation.

In general, markups in the previous example, like <head> and <h2> are referred to as Tags. Their corresponding </head> and </h2> markup with the backslash are called end-Tags. The HTML standard defines a large set of Tags that any web browser is required to understand and process correctly; consequently, web page designers are very familiar with Tags and know how to “customize” them using tag attributes, such as src=“ . . . ” and alt=“ . . . ” on the <img> Tag. Since the application server processes the JSP™ page, Tags other than those standard in HTML can be inserted, and as long as the application server understands them, they can be executed. An example is the <% and %> Tags that the server uses to isolate the embedded Java™ code. A Tag is inherently associated with a JSP™. A feature of JSPs™ is the ability to define and use custom Tags, that neither the server nor the browser need to understand in advance, but that have meaning only in the context of some JSP™ and that is used, for example, as a template for presentation of content. One such set or library of custom Tags is known as a TagLib, short for Tag library. A TagLib may contain as few as one single Tag or literally hundreds of them. The actual TagLib is a file with a special format, understood by the application server, that basically contains two things, namely a description of all the custom Tags, which attributes they support, and the Java™ code that the application server will execute in place of the Tags.

Considering the greeting example above; rather than embedding the actual Java™ code in the JSP™, a Java™ developer can create a self-contained TagLib and give that to the web page designer, who can use it just as easily as standard HTML. The developer can for example create a “greeting” Tag that requires two attributes, namely an AM greeting and a PM greeting. All the web page designer needs to know is the name of the Tag and the required attribute names.

The JSP™ could thus look like this:

<% @taglib prefix=“hp” urn=“. . .” %>
<html>

<head>

<title>Greetings</title>

</head>
<body>

<p><hp:greeting am=“Good Morning!” pm=“Good Afternoon!”!>

</body>

</html>

The above example illustrates the separation of web design markup and Java™ code. TagLibs put the power of Java™ in the hands of web page designers.

As with other standards, HTML has evolved significantly over the years. A major area deals with the “look and feel” of web pages, which means the capabilities of the web designer to add color, pictures, different fonts and other formatting options, to allow for web pages that provide more functionality and in general are visually more attractive.

In order to accomplish this, certain capabilities were added to HTML, namely 1) the ability to specify the layout of text, images and other features, and 2) the ability to manipulate the appearance of text, images and other features.

“Layout” means how the different elements of a page are positioned on the screen (or printed hardcopy) in relation to one another. The elements of a HTML page, shopping cart, for instance, could be displayed in rows and columns using alternating colors and perhaps different size fonts for the product name, SKU number, price, etc. The underlying mechanism in HTML is known as cascading stylesheets (CSS). A feature of CSS is that styles, such as “Arial 12 point in italics with red foreground and blue background” can be stored in a separate file, such as commerce.css or customer-service.css. Each style has a name, and by referring to that name, the HTML element will have the corresponding style applied. The same style names can be used in several different .css files, so depending on which .css is referenced, the HTML may look one way or the other. Since they “cascade,” several .css files can be referenced in sequence, and when the browser looks for the correct style, in reverse order of their reference, such that a “cascade effect” is in play, one .css file can “override” a style declared in a previously referenced .css, which in turn can “override” the same style in yet another, previously referenced .css. By altering one or more .css files, a web page designer can drastically change the entire “look and feel” of a web page—or indeed an entire web site or web based application. There are other kinds of stylesheets that have very different functions.

One common mechanism other than the prevalent JSP™ for generating dynamic content is “templating,” meaning an incomplete web page that can act as a template for an entire page. The greeting example using “templating” for making it dynamic, could look like:

<html>

<head>

<title>Greetings</title>

</head>
<body>

<p>$greeting$

</body>

</html>

The $greeting$ template is placed where the real greeting (Good Morning! or Good Afternoon!) would be displayed. This is known as a place holder and—in the template—identifies its position. There are several “templating” systems or engines in use, which all work more or less the same.

XML is an acronym for extensible Markup Language, and like HTML is a derivative of SGML. However, unlike basically all other markup languages, including HTML, XML has no predefined set of Tags that are defined for the language. For example, HTML has <body>, <head>, <h2>, <p> and so on, but not so XML, which is “free for all.” However, in order for a document or file to be XML, it must be well formed, that is a document must conform to certain syntactical rules, but those rules do not dictate either the names or attributes of the Tags used.

For example, two businesses are doing business together, and whenever one wants to buy something from the other, a purchase order needs to be sent, and once processed, an invoice needs to be sent to the buyer. This document exchange could very well be done electronically and more or less automated, so the businesses could define two XML document types—namely the purchase order and the invoice.

A simple purchase order, in XML, could look like:

<purchase-order>

<product>

<sku>ABC12345</sku>
<price>$12.50</price>
<quantity>1000</quantity>

</product>
<delivery>

<location name=“Prod. Facility 1”>

<address>

<street>123 Main St.</street>
<zip>12345</zip>
<city>Springfield</city>
<state>NJ</state>

<address>

</location>

</delivery>
<payment type=“transfer”>

<amount>$12,500.00</amount>

</payment>

</purchase-order>

The corresponding (oversimplified) invoice could look like:

<invoice>

<product>

<sku>ABC12345</sku>
<price>$12.50</price>
<quantity>1000</quantity>

</product>
<payment>

<amount>$12,500.00</amount>
<tax rate=“6%”>%750.00</tax>
<total>$13,250.00</total>

</payment>

</invoice>

The overall format is similar to HTML, except that the Tags are very application specific. The above documents are syntactically well formed, unlike much of HTML. XML, must be perfectly authored—otherwise it is not well formed and cannot (should not) be processed.

Further than being well formed, XML documents can also be described using either Document Type Definitions (DTD) or XML Schema, which are two relatively similar ways of describing the Tags and attributes (and to some extent values) along with the required/permitted Tag hierarchy. DTDs and Schemas allow the XML processor to validate that a document of a given type is both well formed and also valid with respect to the definition. Most XML documents are processed in two steps, namely, 1) parse the document, and 2) process the parsed result. Several standard parsers exist, and all J2EE application servers are required to have one installed, so Java™ web applications can rely on one being available.

XML can be used for substantially anything that requires the representation of some kind of data in some kind of format. Reasons to use XML include:

(1) It is platform, language and operating system agnostic. For example, an XML purchase order can be created on a Windows™ PC with a Microsoft.Net application and sent to a supplier's J2EE Java™ purchase order application running on HP-UX™.

(2) Unlike many other formats, the document data and the format are both contained in the same document. For example, ABC123412501000123 Main St. is not immediately obvious, whereas the exact same values in the above XML purchase order document make perfect sense.

(3) XML is human and machine producible and consumable; i.e., both software and humans can with relative ease construct XML documents and both humans and software can “understand” the documents.

XML namespaces are opaque names that serve to isolate and provide text. One potential problem with XML is that different entities may define the same Tags but quite possibly define different attributes and schema definitions. Also, as described below, it is often desirable to have XML documents of one type enclose XML documents of another type. If there are two or more definitions for, say, a payment, a client, or an entire purchase order or invoice, if two businesses exchange information (such as purchase orders and invoices) and both have a <client> Tag, each defined differently, namespaces can be used to identify which client Tag is being used. For example:

<purchase-order>

. . .
<hp:client>
. . .
</hp:client>
. . .
<fulbright:client>
. . .
</fulbright:client>

</purchase-order>

In the above example, the same document can now contain two different client Tags—an “HP” one and a “Fulbright” one, because they each belong to different namespaces. Because namespace names are arbitrary, ‘a’ and ‘b’ could produce the same result.

Remote Procedure Call (RPC) is a generic term for a client making a request to a remote (or distributed) server. Among many RPC mechanisms available. SOAP (Simple Object Access Protocol) is implemented by transmitting an XML document, usually using HTTP, and getting another XML document back. SOAP supports two types of client/server calls, namely, 1) RPC—the Remote Procedure Call, and 2) document (or message) exchange.

For RPC, all pertinent information, such as the name of the procedure to call (say, CalculateTax) and the necessary parameters (say $12,500.00 and 6%) are formatted into a SOAP XML document and sent to the remote server; here, the XML is parsed and the correct procedure is called with the supplied parameters, as in:

result=CalculateTax(12500, 0.06);

The result is then formatted into another SOAP XML document and returned to the client.

For document exchange, an XML document of any type is embedded inside a SOAP document and sent to the remote computer, where it's extracted, possibly parsed and passed to the actual server. The purchase order example fits well into this category; SOAP is used merely as a vehicle to get the purchase-order, invoice and sundry confirmation messages sent.

In order for SOAP clients and services to be as generic as possible, they do not themselves contain any SOAP-specific computer code. SOAP uses proxies, too, which are called bindings, which “bind” a request to a particular protocol, server and procedure name (if RPC). When making a SOAP request, the computer code doesn't “see” anything SOAP specific, which is handled by the bindings.

Web Services are servers that are accessible via the web, using SOAP. Consequently there are RPC-style web services and document exchange-style web services. A particular procedure, such as CalculateTax, in a particular web service on a particular machine is called an end point; it is where the SOAP message needs to be sent for processing.

Web Services Descriptor Language (WSDL) is XML with a particular schema, and WSDL documents contain all the detailed information about the web service, such as whether RPC or document exchange, available procedures, their parameters, and all their end-points.

XSL (eXtensible Stylesheet Language) allows the definition of a way to transform an XML document into something else, such as a different kind of XML, HTML, simply plain text, or even Java™ code. XSL is a set of rules that describe what to do when certain Tags are encountered in a document and what the transformed output will look like.

Two other types of XML documents, namely, Voice-XML and WML (Wireless Markup Language), were developed specifically for telephone voice-response systems and low-end wireless devices, such as PDAs and cell-phones. From an end-user point of view, Voice-XML and WML fulfill the same role as HTML does for “normal” web browsers. WML looks somewhat similar to HTML, but Voice-XML is quite different, since it must contain both the speech grammar, the words/touch-tones to recognize as well as the actual information, such as weather or stock quotes.

RSS (RDF Site Summary) is a lightweight multipurpose extensible metadata description and syndication format. RSS is an XML application, conforms to the W3C's RDF (Resource Description Framework) Specification and is extensible via XML-namespace and/or RDF based modularization. RDF basically deals with ontology systems to support the exchange of knowledge. Syndication in general means that one web site takes (borrows, leases, buys) some of its content from a syndication service, possibly somewhere else. For example, sports and news sites commonly use syndication, e.g., Yahoo™ news is mostly syndicated content from elsewhere.

UDDI (Universal Description, Discovery and Integration) is a registry in which web services are described. UDDI itself is a web service in the sense that the protocols used to talk to it are SOAP and HTTP. At a high level, UDDI can be viewed as a yellow-pages book to search for web services. A UDDI registry allows such searches, but using multiple categories and keywords. Also, the outcome of a yellow-pages search is often nothing more than a phone number and perhaps an address, whereas with UDDI the result of a search is among other things the WSDL document that not only explains what a web service can do but also how to communicate with it.

On the Internet, a handful of public UDDI registries exist that allow businesses and organizations to register their web services. Anyone can search these registries and find suitable web services that potentially fit their need. Since a UDDI registry is nothing more than a well-defined web service, private companies and organizations can elect to have one or more dedicated UDDI registries for in-house web services that are available for public consumption.

To use a web service, a UDDI is not mandatory. If the details (i.e., the URL and the WSDL) have been communicated by other means, the web service is still accessible and available for use, in the same manner that a caller who already knows a phone number does not have to look it up in order to call. Put slightly differently, UDDI is most often used during design-time (when the computer code is designed and written) and is most often not needed at run-time (when a user actually runs the computer code).

With the expected proliferation of web services using the SOAP protocol, web content will be produced increasingly by third party companies or organizations. Some archetypal examples discussed above are weather forecasts and stock quotes, but many other areas are equally applicable. Advantageously, web services using SOAP are well defined and described. The protocol is usually HTTP, and SOAP XML messages are sent/received in a well described manner. Importantly, web services are usually registered in one or more public UDDI registries, so they can very easily be found and accessed.

Further, a dichotomy exists between people who create web content (the authors) and people who write computer code (the developers), which has led to technologies like JSP™ and TagLibs. If very disparate information/content can be made available from a large number of sources to be used by web content authors, richer and more functional web applications can be developed without the need for developers.

In order for a web service to be useful, it must be registered somewhere—publicly or privately. It is commonly done in a UDDI registry (a few public ones exist—one of which is run by Hewlett-Packard (HP)). The actual information stored in the registry is among other things an XML document in the WSDL (Web Service Descriptor Language, usually pronounced “wis-del”) that describes that the web service can do (say, provide stock quotes or deliver a weather forecast) and how it must be called (what methods to invoke (say, getQuote), which parameters to supply (say, stockSymbol), and what the response is (say, stockPrice)). This is what makes up a RPC (Remote Procedure Call).

With a WSDL document, a developer can deduce how to format applicable SOAP messages and how to interpret the SOAP response from the web service. This is tedious, so most developers use one or more tools that will interpret the WSDL document and generate some computer code that will do the tedious work. Several vendors and open source initiatives supply these tools and what they actually generate is referred to as a proxy. With a proxy, the developer simply writes computer code that interacts with the proxy, which in turn handles the SOAP/XML/HTTP protocol translation details.

Accordingly, the use of web services traditionally requires computer code development and thus would invariably require a developer to spend time writing very specific computer code, and if later on changes are required, a developer would have to be involved again. One option would be for a developer to generate the proxy and write a TagLib for the particular web service. However, that does not solve the overall problem of developer involvement, namely, whenever a new, useful web service is discovered, An entirely new TagLib (or at least a new Tag) would have to be defined and developed.

In accordance with teachings of the present embodiments, a web content author uses a single, pre-developed TagLib to invoke any method on any web service. An author finds a suitable web service and, using a single TagLib, can invoke methods and obtain results without any computer code generation or developer involvement.

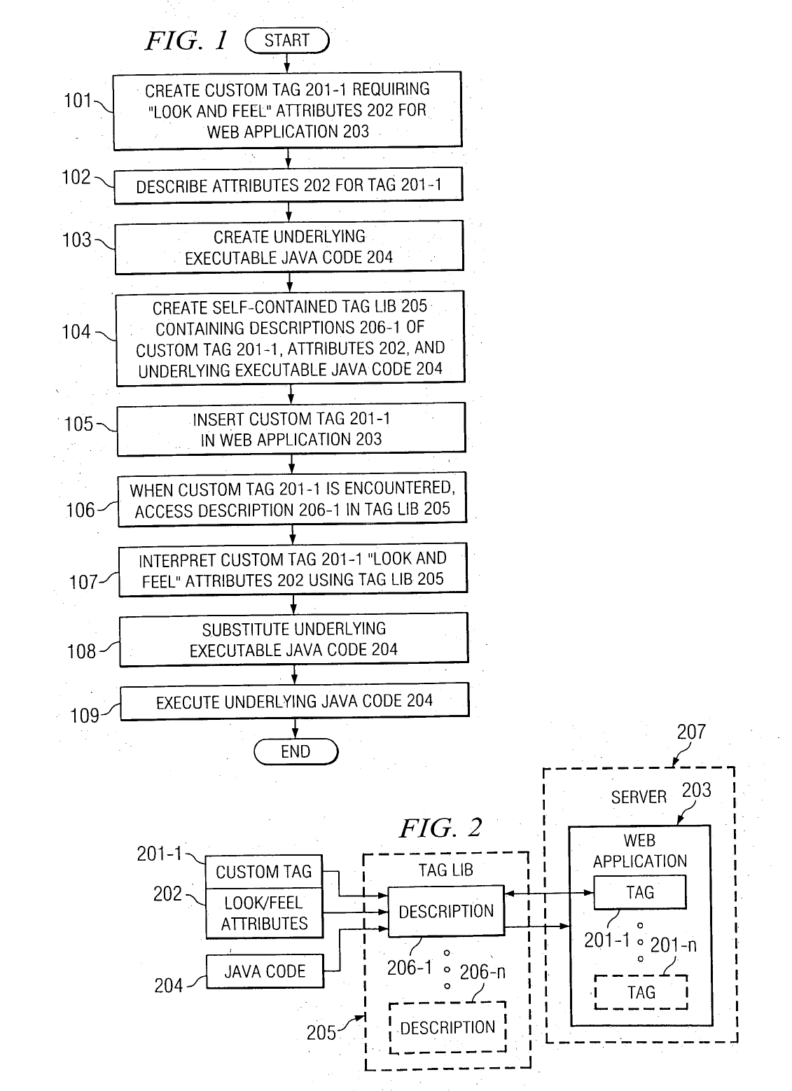

FIG. 1 is a flow diagram depicting a unified method of providing “look and feel” information for a web application using Tag Libraries (TagLibs), in accordance with the present embodiments. FIG. 2 is a schematic representation of the relationships between elements of a unified system for providing “look and feel” information for a web application using TagLibs, in accordance with the present embodiments. At step 101, custom Tag 201-1 requiring “look and feel” attributes 202 desired for web application 203 is created.

“Look and feel” attributes of web pages mean the capabilities of the web designer to add color, pictures, different fonts and other formatting options, to allow for web pages that provide more functionality and in general are visually more attractive. “Look and feel” information provides the ability to specify and manipulate appearance of text and image content including layout color, fonts, resizing, annotation and other formatting aspects in accordance with end-user preferences and/or system-determined settings, typically under control of a stylesheet specified by the web designer and invisible to the end-user. An important aspect of “look and feel” manipulation is its applicability to brand management. A web site, for example a generic portal framework provided by a software company, produces pages that need to appear differently in different contexts. “Look and feel” Tags provide the ability to provide this customization dynamically and “on the fly.” Accordingly this customization need not be an inherent part of the more generic underlying content. For purposes of discussion herein, the terminology “look and feel” information is considered equivalent to the terminology “appearance properties.” Likewise, a “web application” is generally interpreted as equivalent to a JSP™ page.

“Layout” means the positions of the different elements of a page on a screen (or printed hardcopy) relative to one another. Manipulating the appearance of images can encompass the ability to present entirely different image(s) to different users, depending on a number of things, such as user id, locale, gender, and other preferences. For example, a web based e-mail icon appearing to a user in the US might be the standard “loaf of bread with a flag,” whereas a user in Europe might see an entirely different image, representing a typical mailbox in his/her locale. Another example might be an e-commerce™ web application that posts advertising banners as images, in which, instead of having a number of similar images with the same advertising text in different languages, in some embodiments the application is allowed to present only one such image but to annotate it with text specific, e.g., to the user's locale.

At step 102, attributes 202 of Tag 201-1 are described, and at step 103, underlying executable Java™ code 204 is created that defines Tag attributes 202. At step 104, self-contained TagLib 205 is created, containing descriptions 206-1 of custom Tag 201-1, along with its “look and feel” attributes 202 and underlying executable Java™ code 204. A TagLib created at step 104 can contain descriptions 206-1 for as few as one single Tag 201-1 or descriptions 206-1, . . . , 206-n for as many as literally hundreds of Tags 201-1, . . . , 201-n. Tag descriptions 206-1, . . . , 206-n can be added individually or simultaneously to an existing TagLib. Actual TagLib 205 is a file with a special format, understood by application server 207, that contains basically two things, namely description 206-1, . . . , 206-n of all of custom Tags 201-1, . . . , 201-n and which attributes 202 they respectively support, and corresponding Java™ code 204 that application server 207 will execute in place of the Tags.

The operations depicted in steps 101-104 are performed typically by a Java™ developer, which then supplies the result to a web page designer. At step 105, custom Tag 201-1 is inserted, typically by the web page designer, into web application (e.g., JSP™ page) 203. When a client requests content from a URL that application server 207 resolves to web application 203, then web application 203 is processed, sequentially as encountered, based on the request, and text is written to a response stream. At step 106 when application server 207 encounters custom Tag 201-1 previously inserted at step 105 in web application 203, corresponding description 206-1 of custom Tag 201-1 is then accessed in TagLib 205, which provides application server 207 with the ability to interpret “look and feel” attributes 202 of inserted custom Tag 201-1, as depicted at step 107. At step 108, underlying Java™ code 204 written to implement custom Tag 201-1 is provided from TagLib 205 and substituted for corresponding Tag “look and feel” attribute 202, and at step 109 is executed in place of inserted custom Tag 201-1. The Tag itself is generally implemented in Java™ code, and substitution is generally performed by invoking cascading style sheets (CSS). Some architectures use a database table lookup in TagLib 205 to implement the CSS.

In practice, a single custom Tag 201-1 or multiple custom Tags 201-1, . . . , 201-n can be inserted into a given web application, for example web application 203. TagLibs are easier to use by a web page designer rather than embedding actual Java™ code 204 in the web application, and all information provided by the Java™ developer is available in one place, namely the TagLib. All a web page designer needs to know is the name of the Tag and the required attribute names. The methods described above illustrate how Tags allow added dynamic content in new ways to an otherwise simple web application that looks very much like an XML document. “Look and feel” Tags are generally useful even outside the context of dynamically rendered content. In other words, they are useful independent of whether or not a Java™ developer is involved in designing the web site.

Importantly, the embodiments herein provide the ability to dynamically alter the look and feel of a web application based on end-user preference and/or “system-determined” settings. For example, a user might want to see a web page using different fonts/colors than those of another user. As a further example, one user might prefer black text, using the Arial font, but the color scheme for the application is controlled by a company or institutional standard, such as blue/white for Hewlett-Packard. Additionally, for example, an end-user could be allowed to specify the size for “tool-bar” icons/images but would not be allowed to specify the size for advertising images. The above examples serve to illustrate the power and flexibility of the embodiments.

What is claimed is:

1. A method of providing appearance properties information for a web application, said method comprising:
creating a Tag having attributes that describe said appearance properties information;
creating corresponding computer code that implements said appearance properties attributes in said web application;
containing a description of said Tag with related attributes, and corresponding computer code in a Tag Library (TagLib);
inserting said Tag into said web application;
when said inserted Tag is encountered in said web application, then accessing said description of said Tag with related attributes, and corresponding computer code in said TagLib; and
implementing said accessed appearance properties attributes in said web application by executing said corresponding computer code in place of said Tag.

2. The method of claim 1 wherein said appearance properties information includes the ability to specify and manipulate appearance of text and image content including layout, color, fonts, resizing, annotation and formatting aspects.

3. The method of claim 2 wherein said specifying and manipulating are determined by end-user preferences.

4. The method of claim 2 wherein said specifying and manipulating are determined by system-determined settings.

5. The method of claim 2 wherein said specifying and manipulating are performed under control of a stylesheet.

6. The method of claim 5 wherein said stylesheet is invisible to the end-user.

7. The method of claim 1 wherein said corresponding computer code is a form of Java™ code.

8. The method of claim 1 further comprising containing descriptions of a plurality of Tags with related attributes and corresponding computer code in said TagLib.

9. The method of claim 1 further comprising inserting a plurality of Tags into said web application.

10. The method of claim 1 wherein said web application runs in an application server.

11. A system for providing appearance properties information for a web application, said system comprising:
a Tag having attributes that describe said appearance properties information;
corresponding computer code operable to implement said appearance properties attributes in said web application; and
a Tag Library (TagLib) operable to contain a description of said Tag with related attributes and corresponding computer code, and operable to provide said corresponding computer code when accessed from said web application.

12. The system of claim 11 wherein said appearance properties information includes the ability to specify and manipulate appearance of text and image content including layout color, fonts, resizing, annotation and formatting aspects.

13. The system of claim 12 wherein said specifying and manipulating are determined by end-user preferences.

14. The system of claim 12 wherein said specifying and manipulating are determined by system-determined settings.

15. The system of claim 12 wherein said specifying and manipulating are performed under control of a stylesheet.

16. The system of claim 15 wherein said stylesheet is invisible to the end-user.

17. The system of claim 11 wherein said corresponding computer code is a form of Java™ code.

18. The system of claim 11 wherein said TagLib is further operable to contain descriptions of a plurality of Tags with related attributes and corresponding computer code.

19. The system of claim 11 wherein said web application is operable to contain a plurality of inserted Tags.

20. The system of claim 11 wherein said web application runs in an application server.

21. A system for providing appearance properties information for a web application, said system comprising:
means for creating a Tag having attributes that describe said appearance properties information;
means for creating corresponding computer code that implements said appearance properties attributes in said web application;
means for containing a description of said Tag with related attributes, and corresponding computer code in a Tag Library (TagLib);
means for inserting said Tag into said web application;
means for accessing said description of said Tag with related attributes, and corresponding computer code in said TagLib, when said inserted Tag is encountered in said web application; and
means for implementing said accessed appearance properties attributes in said web application by executing said corresponding computer code in place of said Tag.

22. The system of claim 21 further comprising means for specifying and manipulating appearance of text and image content including layout, color, fonts, resizing, annotation and formatting aspects.

23. The system of claim 22 comprising said means for specifying and manipulating determined by end-user preferences.

24. The system of claim 22 comprising said means for specifying and manipulating determined by system-determined settings.

25. The system of claim 22 comprising said means for specifying and manipulating under control of a stylesheet.

26. The system of claim 21 wherein said corresponding computer code is a form of Java™ code.

27. The system of claim 21 further comprising means for containing descriptions of a plurality of Tags with related attributes and corresponding computer code.

28. The system of claim 21 further comprising means for inserting a plurality of Tags into said web application.

29. Computer-executable software code stored to a computer-readable medium, said computer-executable software code comprising:
software code for creating a Tag having attributes that describe appearance properties information;
software code for creating corresponding computer code that implements said appearance properties attributes in a web application;
software code for containing a description of said Tag with related attributes, and corresponding computer code in a Tag Library (TagLib);
software code for inserting said Tag into said web application;
software code for accessing said description of said Tag with related attributes, and corresponding computer code in said TagLib, when said inserted Tag is encountered in said web application; and
software code for implementing said accessed appearance properties attributes in said web application by executing said corresponding computer code in place of said Tag.

30. The computer-executable software code of claim 29 further comprising software code for specifying and manipulating appearance of text and image content including layout, color, fonts, resizing, annotation and formatting aspects.

31. The computer-executable software code of claim 30 comprising software code for specifying and manipulating determined by end-user preferences.

32. The computer-executable software code of claim 30 comprising software code for specifying and manipulating determined by system-determined settings.

33. The computer-executable software code of claim 30 comprising software code for specifying and manipulating under control of a stylesheet.

34. The computer-executable software code of claim 29 wherein said corresponding software code is a form of Java™ code.

35. The computer-executable software code of claim 29 further comprising software code for containing descriptions of a plurality of Tags with related attributes and corresponding software code.

36. The computer-executable software code of claim 29 further comprising software code for inserting a plurality of Tags into said web application.
